(19) United States
(12) Patent Application Publication
(10) Pub. No.: US 2015/0163463 A1
(43) Pub. Date: Jun. 11, 2015

(54) SYSTEMS AND METHODS FOR OPERATING A DOORBELL CAMERA

(71) Applicant: Vivint, Inc., Provo, UT (US)

(72) Inventors: Jungtaik Hwang, Draper, UT (US); Matthew J. Eyring, Provo, UT (US); Jeremy Bruce Warren, Draper, UT (US); James Ellis Nye, Alpine, UT (US)

(21) Appl. No.: 14/561,633

(22) Filed: Dec. 5, 2014

Related U.S. Application Data
(60) Provisional application No. 61/912,945, filed on Dec. 6, 2013.

(51) Int. Cl. H04N 7/18

(52) U.S. Cl. CPC H04N 7/188

(57) ABSTRACT

A computer-implemented method for a doorbell camera is described. In one embodiment, an image is captured using a camera in a doorbell unit. The doorbell unit is wired to doorbell wiring. The doorbell wiring includes a first wire and a second wire. Data associated with the capturing of the image is sent over the doorbell wiring. The data associated with capturing of the image is received, over doorbell wiring, at a chime unit.

### CROSS REFERENCE

This application claims priority from co-pending U.S. Provisional Patent Application No. 61/912,945 entitled “SYSTEMS AND METHODS FOR OPERATING A DOORBELL CAMERA,” which was filed 6 Dec. 2013, and assigned to the assignee hereof.

### BACKGROUND

Advancements in media delivery systems and media-related technologies continue to increase at a rapid pace. Increasing demand for media has influenced the advances made to media-related technologies. Computer systems have increasingly become an integral part of the media-related technologies. Computer systems may be used to carry out several media-related functions. The wide-spread access to media has been accelerated by the increased use of computer networks, including the Internet and cloud networking.

Many homes and businesses use one or more computer networks to generate, deliver, and receive data and information between the various computers connected to computer networks. Users of computer technologies continue to demand increased access to information and an increase in the efficiency of these technologies. Improving the efficiency of computer technologies is desirable to those who use and rely on computers.

With the wide-spread use of computers and mobile devices has come an increased presence of home automation and home security products. Advancements in mobile devices allow users to monitor a home or business. As a result, benefits may be realized by providing systems and methods for a doorbell camera in relation to home automation systems.

### SUMMARY

According to at least one embodiment, a computer-implemented method for operating a doorbell camera is described. In one embodiment, an image may be captured using a camera in a doorbell unit. The doorbell unit may be wired to doorbell wiring. The doorbell wiring may include a first wire and a second wire. Data associated with the capturing of the image may be sent over the doorbell wiring.

In one embodiment, the doorbell wiring may include at least a portion of preexisting doorbell wiring that predates an installation of the doorbell unit. Installation of the doorbell unit may include replacing a preexisting doorbell unit with the doorbell unit, the preexisting doorbell unit being wired with the preexisting doorbell wiring. In some embodiments, images may be captured continuously, via the camera, at a predetermined frame rate according to a setting of a user policy.

In one embodiment, motion may be detected via a sensor in the doorbell unit. Upon detecting the motion via the sensor, one or more images may be captured via the camera. Upon determining that the camera is set to record continuously, a frame rate of the camera may be adjusted from a first frame rate to a second frame rate upon detecting the motion via the sensor. In one embodiment, a press of a button on the doorbell unit may be detected. Upon detecting the press of the button, one or more images may be captured via the camera. Upon determining that the camera is set to record continuously, a frame rate of the camera may be adjusted from a first frame rate to a second frame rate upon detecting the press of the button.

In some cases, a request to capture one or more images using the camera may be received over the doorbell wiring. The requested one or more images may be sent to a computing device for display. The data from the doorbell unit may be sent, over the doorbell wiring, to a chime unit. The doorbell unit may be installed on an exterior of a dwelling and the chime unit may be installed on an interior of the dwelling.

According to at least one embodiment, another computer-implemented method for a doorbell camera is described. Data associated with capturing an image using a camera in a doorbell unit may be received at a chime unit. The data may be sent over doorbell wiring between the chime unit and the doorbell unit. The doorbell wiring may include a first wire and a second wire.

In one embodiment, the data received at the chime unit may be sent to a control unit over a data communication network. A request to capture one or more images using the camera in the doorbell unit may be received at the chime unit. The request may be sent from the chime unit to the doorbell unit over the doorbell wiring. The requested one or more images may be received, over the doorbell wiring, at the chime unit. In some cases, the requested one or more images may be sent, over a data communication network, from the chime unit to a control unit. In one embodiment, the requested one or more images may be sent, over a data communication network, from the chime unit to a computing device over a data communication network.

According to another embodiment, an apparatus for operating a doorbell camera is described. The apparatus includes a processor, memory in electronic communication with the processor, and instructions stored in the memory. The instructions are executable by the processor to capture an image using a camera in a doorbell unit, the doorbell unit being wired to doorbell wiring, the doorbell wiring comprising a first wire and a second wire, and send data associated with the capturing of the image over the doorbell wiring.

In one embodiment, the doorbell wiring may include at least a portion of preexisting doorbell wiring that predates an installation of the doorbell unit. The installation of the doorbell unit may include replacing a preexisting doorbell unit with the doorbell unit, wherein the preexisting doorbell unit is wired with the preexisting doorbell wiring. The instructions may be further executable by the processor to continuously capture images via the camera at a predetermined frame rate according to a setting of a user policy.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating another embodiment of an environment in which the present systems and methods may be implemented;

FIG. 3 is a block diagram illustrating one example of a data module;

FIG. 4 is a flow diagram illustrating one embodiment of a method for relaying an image captured using a doorbell camera over conventional doorbell wiring;

FIG. 5 is a flow diagram illustrating one embodiment of a method for adjusting how doorbell camera captures one or more images a based on a triggering event;

FIG. 6 is a flow diagram illustrating one embodiment of a method for receiving, over conventional doorbell wiring, data associated with capturing an image using a doorbell camera;

FIG. 7 is a flow diagram illustrating one embodiment of a method for communicating data related to the capture of one or more images using a doorbell camera; and

FIG. 8 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods described herein relate to home automation. More specifically, the systems and methods described herein relate to a doorbell camera in relation to a home automation system. Some embodiments of the systems and methods described herein relate to a doorbell camera in relation to an integration of home automation and a subscriber-based media content set top box, such as a satellite and/or cable digital video recorder (DVR).

In one example, a user may desire to receive an alert when someone enters a predefined area. For instance, a person may want to know when a person comes to a door of his or her house, office, or place of business. The present systems and methods may detect when a person approaches a door and/or presses a doorbell button and providing notification messages upon detecting the person at the door. Moreover, the systems and methods described herein may provide a doorbell camera to capture an image of the person that approaches a door and/or presses a doorbell button. The captured image may be relayed to one or more devices where a user is able to view the captured image. For example, the image may be sent to one or more computing devices (e.g., desktop computer, laptop computer, mobile computer, etc.), to a screen of a home automation control unit, and/or other viewing devices such as a television and the like.

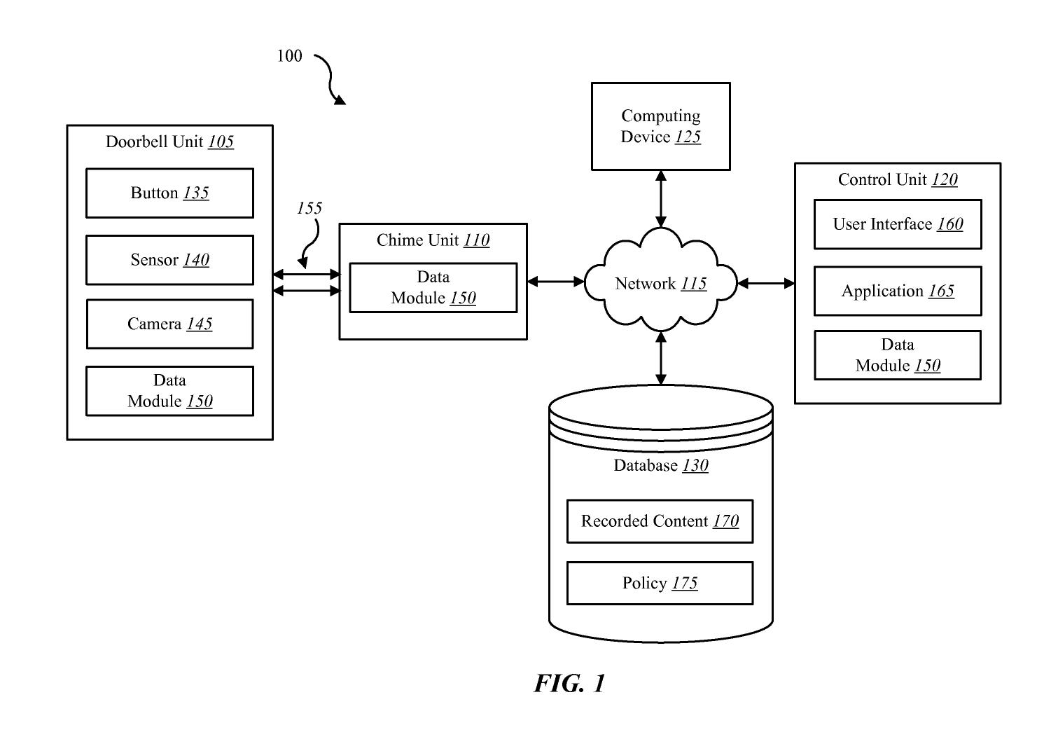

FIG. 1 is a block diagram illustrating one embodiment of an environment 100 in which the present systems and methods may be implemented. In some embodiments, the systems and methods described herein may be performed in relation to on one or more devices illustrated in environment 100. The environment 100 may include doorbell unit 105, chime unit 110, control unit 120, computing device 125, database 130, and a network 115 that allows doorbell unit 105, chime unit 110, control unit 120, computing device 125, and database 130 to communicate with one another. Examples of computing device 125 may include a media content set top box, satellite set top box, cable set top box, DVR, personal video recorders (PVRs), mobile devices, smart phones, personal computing devices, computers, servers, etc. Examples of the control unit 120 include a dedicated home automation computing device (e.g., wall-mounted controller), a personal computing device (e.g., laptop, desktop, etc.), a mobile computing device (e.g., tablet computing device, smartphone, etc.), and the like.

Doorbell unit 105 may include a button 135, a sensor 140, a camera 145, and a data module 150. Doorbell unit 105 may connect to chime unit 110 using doorbell wiring 155. Doorbell wiring 155 may include wiring conventionally used to wire a typical doorbell unit to a typical chime unit. Such conventional wiring may be used to illuminate a doorbell button and/or to sound one or more tone bars inside a typical chime unit.

In the conventional doorbell design, a solenoid piston includes an iron core mounted to a non-magnetic metal rod. The solenoid piston is positioned within a wire coil, which forms an electromagnet when power is applied to the chime unit (i.e., when someone pushes the doorbell button the circuit of the wire coil is closed). A spring is wrapped around the solenoid piston to keep the solenoid piston at a resting position when no power is applied to the chime unit (i.e., when no one is pushing the doorbell button the circuit of the wire coil is open). At the resting position, at least part of the iron core of the solenoid piston extends outside of the wire coil. When the wire coil electromagnet is activated (by pressing the doorbell button to close the circuit), the iron core is drawn to the magnetic field generated by the wire coil electromagnet, causing the solenoid piston to move within the coiled wire. As the solenoid piston is pulled by the activated wire coil, one end of the piston strikes a tone bar. The tone bar vibrates, producing a particular tone. As long as the doorbell button is pressed, current flows through the electromagnet wire coil causing the piston to remain in this non-resting position. When the doorbell button is released, the circuit of the wire coil is broken, cutting off the current flowing through the electromagnet wire coil, which causes the wire coil's magnetic field to collapse. The spring on the solenoid piston then snaps the piston back to its resting position, where the other end of the piston hits another tone bar on the other side of the chime unit.

Doorbell wiring may include two wires. A first wire runs from the doorbell unit to one end of the wire coil in the chime unit. A second wire runs from the doorbell unit to one end of a transformer. The transformer transforms a typical household 120-volt current and steps the voltage down to a voltage typically within the range of 5 to 24 volts. The second wire exits the transformer and connects to the other end of the wire coil in the chime unit. Doorbell wiring 155 may include first and second wires similar to those described above. In some embodiments, at least one wire from doorbell wiring 155 may be rewired to bypass a transformer resulting in two wires running directly from doorbell unit 105 to chime unit 110.

As described above, doorbell unit 105 may include sensor 140. Examples of sensor 140 include a camera sensor, audio sensor, proximity sensor, motion sensor, accelerometer, capacitance sensor, radio frequency sensor, near-field sensor, voice sensor, and the like. Sensor 140 may represent one or more separate sensors or a combination of two or more sensors in a single device. For example, sensor 140 may represent one or more camera sensors and one or more motion sensors. Sensor 140 may be integrated with a facial recognition system.

In some configurations, the control unit 120 may include a user interface 160, application 165, and data module 150. Although the components of the doorbell unit 105 are depicted as being internal to the doorbell unit 105, it is understood that one or more of the components may be external to the doorbell unit 105 and connect to doorbell unit 105 through wired and/or wireless connections. In some embodiments, application 165 may be installed on computing device 125 in order to allow a user to interface with a function of doorbell unit 105, data module 150, control unit 120, and/or service provider device 110.

In some embodiments, doorbell unit 105 may communicate with control unit 120, computing device 125, and/or database 130 via a communication path that includes a combination of doorbell wiring 155, chime unit 110, and network 115. Examples of network 115 include cloud networks, local area networks (LAN), wide area networks (WAN), virtual private networks (VPN), wireless networks (using 802.11, for example), cellular networks (using 3G and/or LTE, for example), etc. In some configurations, the network 115 may include the internet. It is noted that in some embodiments, the doorbell unit 105 may not include a data module 150. In some embodiments, doorbell unit 105, control unit 120, and/or service provider device 110 may include data module 150, where at least a portion of the functions of data module 150 are performed separately and/or concurrently on doorbell unit 105, control unit 120, and/or service provider device 110. Likewise, in some embodiments, a user may access one or more functions of doorbell unit 105, chime unit 110, database 130, and/or control unit 120 from computing device 125. For example, in some embodiments, computing device 125 includes a mobile application that interfaces with one or more functions of doorbell unit 105, control unit 120, chime unit 110, and/or database 130.

In some embodiments, one or more devices illustrated in environment 100 may be coupled to database 130. Database 130 may include recorded content 170 and policy 175. Recorded content 170 may include one or more images captured using camera 145. For example, computing device 125 may access recorded content 170 in database 130 over network 115. In some embodiments, database 130 may be internal or external to one or more devices of environment 100 al (e.g., connected to a device through network 115 and/or connected directly to one or more devices of environment 100). For example, at least a portion of database 130 may be internal or external to doorbell unit 105, chime unit 110, control unit 120, and/or computing device 125.

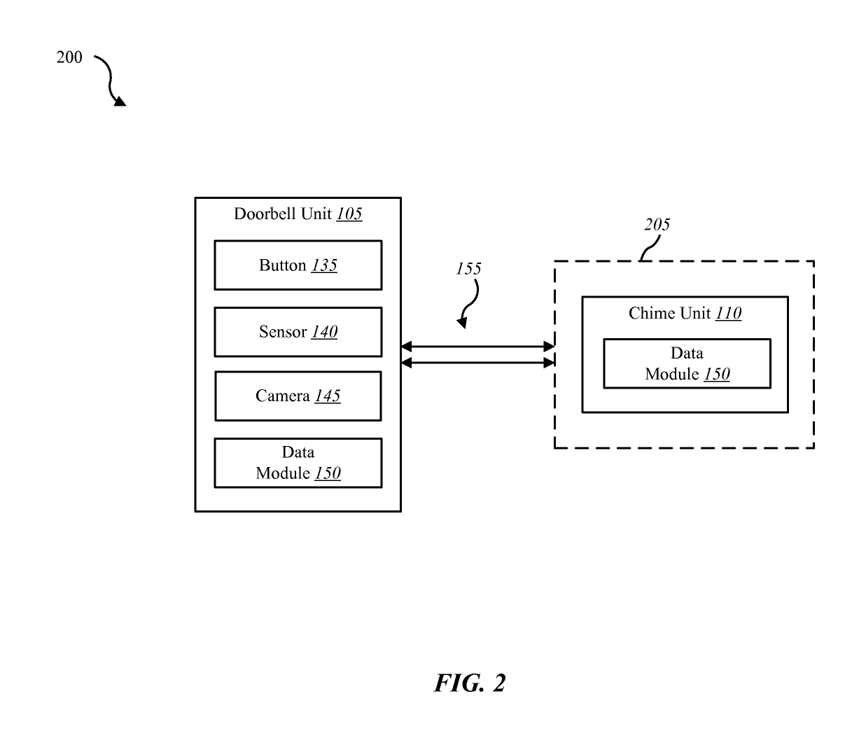

FIG. 2 is a block diagram illustrating another embodiment of an environment 200 in which the present systems and methods may be implemented. In some embodiments, the systems and methods described herein may be performed in relation to on one or more devices illustrated in environment 200. The environment 200 may include doorbell unit 105 and chime unit 110. Environment 200 may be one example of environment 100 of FIG. 1. Although certain elements depicted in environment 100 are not illustrated in environment 200, it is understood that one or more of those elements may be part of environment 200. Chime unit 110 may connect to doorbell unit 105 over doorbell wiring 155. In one embodiment, chime unit 100 may be located within an interior space of a dwelling 205. Doorbell unit 105 may be located at a location external to dwelling 205. For example, doorbell unit 105 may be located on an external wall of dwelling 205 and chime unit 110 may be mounted on an interior wall of dwelling 205.

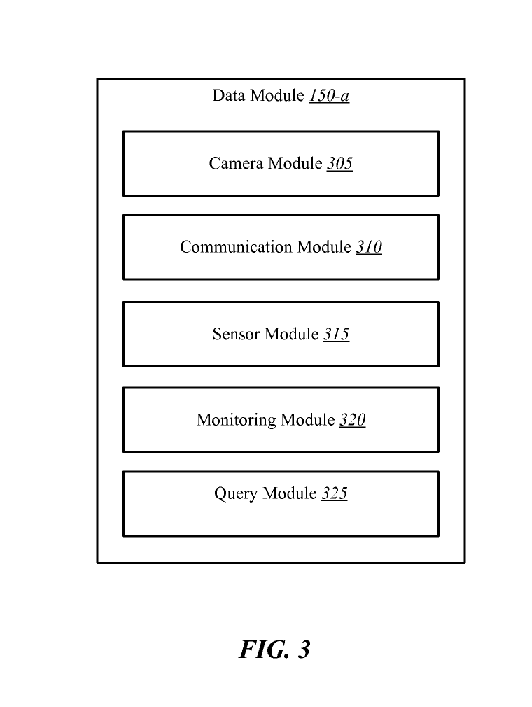

FIG. 3 is a block diagram illustrating one example of a data module 150-a. Data module 150-a may be one example of data module 150 depicted in FIGS. 1 and/or 2. As depicted, data module 150-a may include a camera module 305, a communication module 310, a sensor module 315, a monitoring module 320, and a query module 325.

In one embodiment, camera module 305 may capture an image using a camera in a doorbell unit (e.g., doorbell unit 105). The doorbell unit may be wired to doorbell wiring (e.g., doorbell wiring 155). The doorbell wiring may include a first wire and a second wire. The doorbell wiring may include at least a portion of preexisting doorbell wiring that predates an installation of the doorbell unit. In some cases, the installation of the doorbell unit may include replacing a preexisting doorbell unit with the doorbell unit. The preexisting doorbell unit may have been wired with the preexisting doorbell wiring. In some embodiments, communication module 310 may send, over the doorbell wiring, data associated with the capturing of the image by the camera in the doorbell unit. For example, communication module 310 may relay a captured image over the doorbell wiring.

In some cases, camera module 305 may continuously capture, at a predetermined frame rate, images via the doorbell camera. The predetermined frame rate may be determined according to a setting of a user policy (e.g., user policy 175). In one embodiment, sensor module 315 may detect motion via a sensor in the doorbell unit. Upon detecting the motion via the sensor, camera module 305 may capture one or more images via the doorbell camera. Upon determining that the doorbell camera is set to record continuously, camera module 305 may adjust a frame rate of the camera from a first frame rate to a second frame rate upon detecting the motion via the sensor.

In one embodiment, monitoring module 320 may detect a press of a button on the doorbell unit (e.g., a press of button 135). Upon detecting the press of the button, camera module 305 may capture one or more images via the doorbell camera. Upon determining that the camera is set to record continuously, camera module 305 may adjust a frame rate of the camera from a first frame rate to a second frame rate upon detecting the press of the button.

In some cases, query module 325 may receive, over the doorbell wiring, a request to capture one or more images using the doorbell camera. In one embodiment, communication module 310 may send the requested one or more images to a computing device for display. For example, an image captured using the doorbell camera may be sent over the doorbell wiring to the chime unit. The chime unit may then send the captured image to a computing device over a data network, including wired and/or wireless network connections. In some cases, the doorbell unit may send the captured image directly to the computing device using a data networking connection of one or more wired and/or wireless network connections. In one embodiment, communication module 310 may send, over the doorbell wiring, the data from the doorbell unit to a chime unit where the doorbell unit may be installed on an exterior of a dwelling and the chime unit may be installed on an interior of the same dwelling.

In one embodiment, communication module 310 may receive, at a chime unit, data associated with capturing an image using a camera in a doorbell unit. The data may be sent over doorbell wiring between the chime unit and the doorbell unit (e.g., doorbell wiring 155). Communication module 310 may send the data received at the chime unit to a control unit over a data communication network. For example, data received at chime unit 110 may be sent to control unit 120 over network 115. In some embodiments, communication module 310 may receive a request to capture one or more images using the camera in the doorbell unit. Communication module 310 may send, from the chime unit, the request to the doorbell unit over the doorbell wiring. In response, communication module 310 may receive, at the chime unit, the requested one or more images over the doorbell wiring. In some cases communication module 310 may send, from the chime unit, the requested one or more images to a control unit over a data communication network. Additionally, or alternatively, communication module 310 may send, from the chime unit, the requested one or more images to a computing device over a data communication network. For example, communication module 310 may send the requested one or more images from chime unit 110 to computing device 125, control unit 120, and/or database 130 over network 115.

In one embodiment, communication module 310 may generate a notification in response to detecting one or more images captured by a doorbell camera. In some embodiments, communication module 310, in conjunction with the user interface 160, may display a notification on a display connected to control unit 120. In some embodiments, communication module may send a captured image and/or a notification to a set top box. Communication module 310 may display the notification in relation to a presently viewed channel of subscriber program content. In some cases, communication module 310 may display the notification in at least a portion of a viewing area of the channel. For example, a user watching content from a satellite DVR on a television may receive a notification displayed on at least a portion of the screen of the television. In relation to a set-top box service, the notification may include a scrolling message, a picture-in-picture message, and/or switching to a notification or monitoring channel that includes data and/or information in relation to the detected action. For example, a channel dedicated to displaying images captured by a doorbell camera may be integrated within a channel guide of subscriber program content. Thus, in some cases, images captured using a doorbell camera may be recorded and stored in a DVR or other similar media storage and/or viewing device.

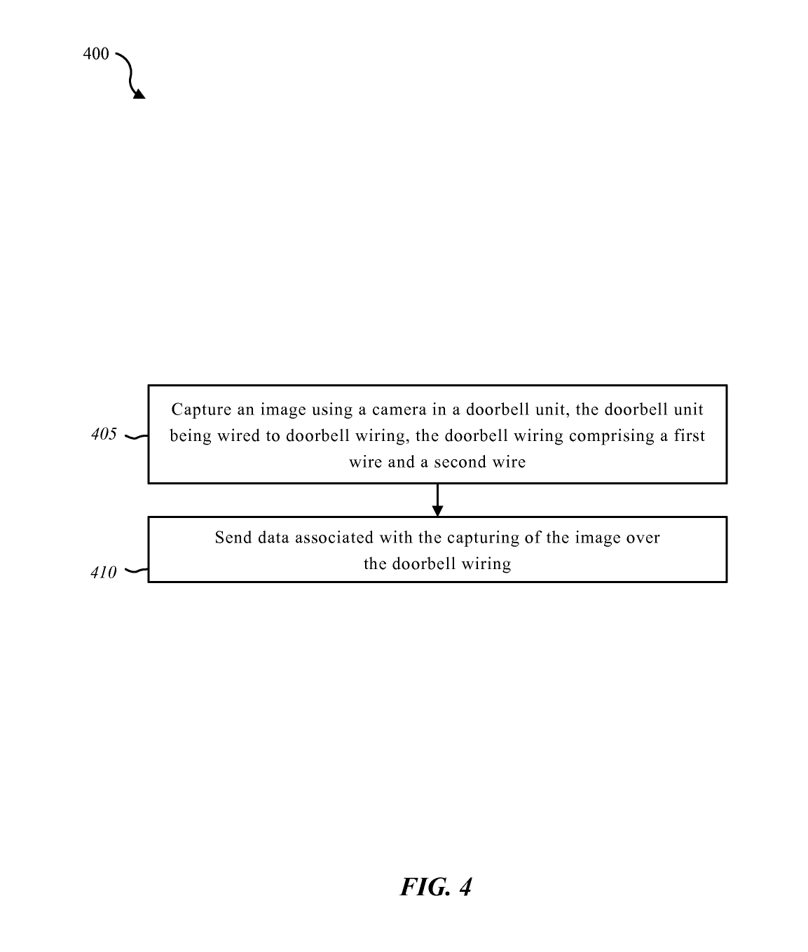

FIG. 4 is a flow diagram illustrating one embodiment of a method 400 for relaying an image captured using a doorbell camera over conventional doorbell wiring. In some configurations, the method 400 may be implemented by the data module 150 illustrated in FIG. 1, 2, or 3. In some configurations, the method 400 may be implemented in conjunction with the application 165 and/or the user interface 160 illustrated in FIG. 1.

At block 405, an image may be captured using a camera in a doorbell unit. The doorbell unit may be wired to doorbell wiring where the doorbell wiring may include a first wire and a second wire. At block 410, data associated with the capturing of the image may be sent over the doorbell wiring. For example, the data, which may include the captured image, may be sent over the doorbell wiring to a chime unit.

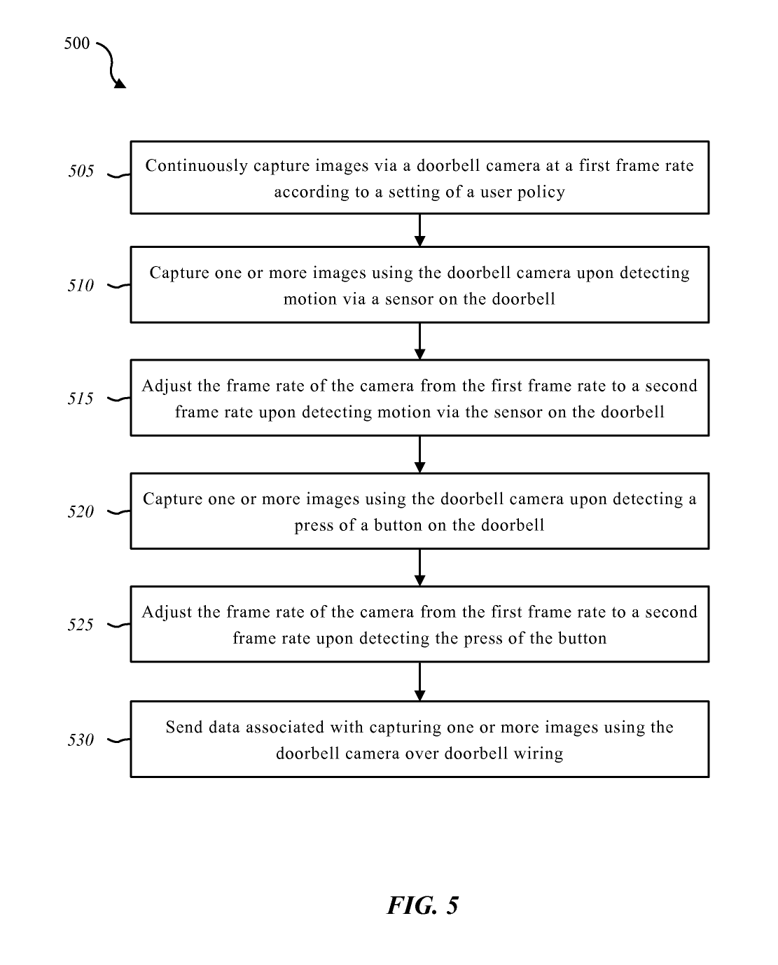

FIG. 5 is a flow diagram illustrating one embodiment of a method 500 for adjusting how doorbell camera captures one or more images a based on a triggering event. In some configurations, the method 500 may be implemented by the data module 150 illustrated in FIG. 1, 2, or 3. In some configurations, the method 500 may be implemented in conjunction with the application 165 and/or the user interface 160 illustrated in FIG. 1.

At block 505, images may be continuously captured via a doorbell camera at a first frame rate. The first frame rate may be set according to a setting of a user policy. At block 510, one or more images may be captured using the doorbell camera upon detecting a triggering event via a sensor on the doorbell. For example, a sensor on the doorbell may detect an infrared heat signature and/or motion. At block 515, the frame rate of the camera may be adjusted from the first frame rate to a second frame rate upon detecting motion via the sensor on the doorbell. For example, the first frame rate may be set to a relatively low frame rate according to a continuous image capture mode (e.g., less than 15 frames per second). The second frame rate may be set to a relatively high frame rate (e.g., above 15 frames per second).

At block 520, one or more images may be captured using the doorbell camera upon detecting a press of a button on the doorbell. At block 525, the frame rate of the doorbell camera may be adjusted from the first frame rate to a second frame rate upon detecting the press of the button. At block 530, data associated with capturing one or more images using the doorbell camera may be sent to one or more devices over the doorbell wiring (e.g., sent to a chime unit).

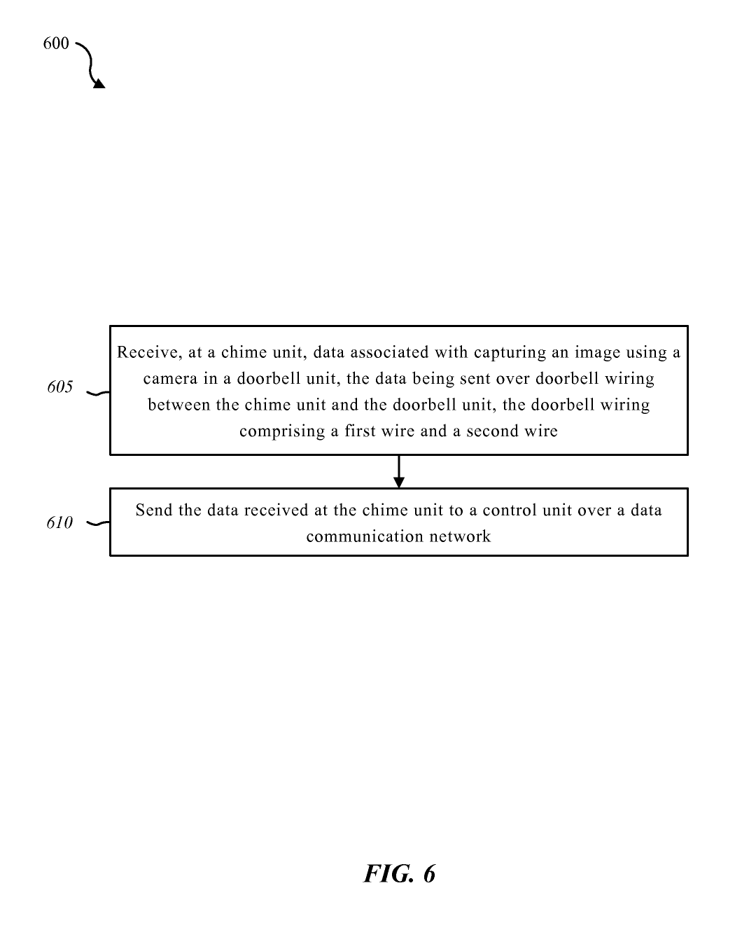

FIG. 6 is a flow diagram illustrating one embodiment of a method 600 for receiving, over conventional doorbell wiring, data associated with capturing an image using a doorbell camera. In some configurations, the method 600 may be implemented by the data module 150 illustrated in FIG. 1, 2, or 3. In some configurations, the method 600 may be implemented in conjunction with the application 165 and/or the user interface 160 illustrated in FIG. 1.

At block 605, data associated with capturing an image using a camera in a doorbell unit may be received, at a chime unit. The data may be sent over doorbell wiring between the chime unit and the doorbell unit. The doorbell wiring may include a first wire and a second wire. At block 610, the data received at the chime unit may be sent to a control unit over a data communication network.

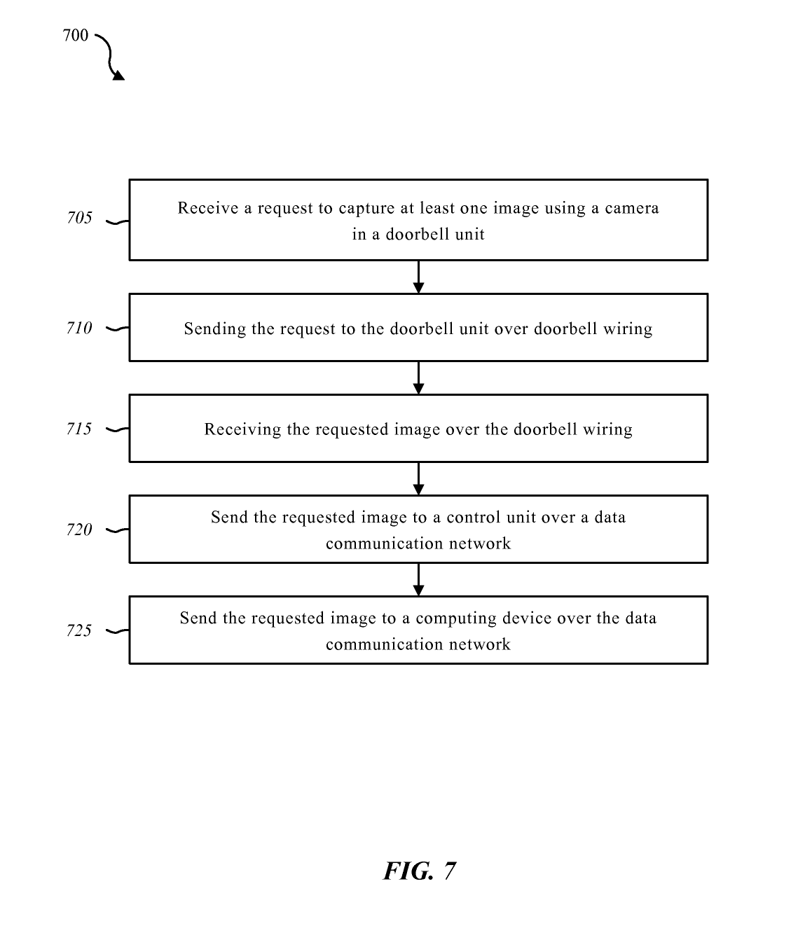

FIG. 7 is a flow diagram illustrating one embodiment of a method 700 for communicating data related to the capture of one or more images using a doorbell camera. In some configurations, the method 700 may be implemented by the data module 150 illustrated in FIG. 1, 2, or 3. In some configurations, the method 700 may be implemented in conjunction with the application 165 and/or the user interface 160 illustrated in FIG. 1.

At block 705, a request to capture at least one image using a camera in a doorbell unit may be received. At block 710, the request may be sent to the doorbell unit over doorbell wiring. At block 715, upon capturing the requested image, the requested image may be received over the doorbell wiring. At block 720, the requested image may be sent to a control unit over a data communication network. At block 725, the requested image may be sent to a computing device over the data communication network.

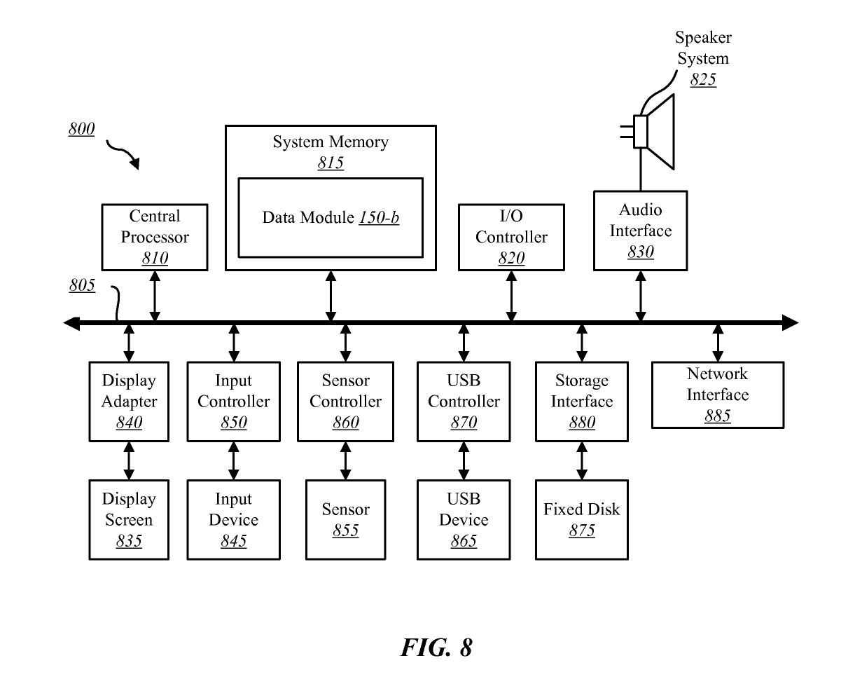

FIG. 8 depicts a block diagram of a controller 800 suitable for implementing the present systems and methods. The controller 800 may be an example of doorbell unit 105, chime unit 110, computing device 125, database 130, and/or control unit 120 illustrated in FIG. 1. In one configuration, controller 800 includes a bus 805 which interconnects major subsystems of controller 800, such as a central processor 815, a system memory 820 (typically RAM, but which may also include ROM, flash RAM, or the like), an input/output controller 825, an external audio device, such as a speaker system 830 via an audio output interface 835, an external device, such as a display screen 835 via display adapter 840, an input device 845 (e.g., remote control device interfaced with an input controller 850), multiple USB devices 865 (interfaced with a USB controller 870), and a storage interface 880. Also included are at least one sensor 855 connected to bus 805 through a sensor controller 860 and a network interface 885 (coupled directly to bus 805).

Bus 805 allows data communication between central processor 815 and system memory 820, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the data module 150-b to implement the present systems and methods may be stored within the system memory 820. Applications (e.g., application 165) resident with controller 800 are generally stored on and accessed via a non-transitory computer readable medium, such as a hard disk drive (e.g., fixed disk 875) or other storage medium. Additionally, applications can be in the form of electronic signals modulated in accordance with the application and data communication technology when accessed via interface 885.

Storage interface 880, as with the other storage interfaces of controller 800, can connect to a standard computer readable medium for storage and/or retrieval of information, such as a fixed disk drive 875. Fixed disk drive 875 may be a part of controller 800 or may be separate and accessed through other interface systems. Network interface 885 may provide a direct connection to a remote server via a direct network link to the Internet via a POP (point of presence). Network interface 885 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to controller 800 wirelessly via network interface 885.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 8 need not be present to practice the present systems and methods. The devices and subsystems can be interconnected in different ways from that shown in FIG. 8. The aspect of some operations of a system such as that shown in FIG. 8 are readily known in the art and are not discussed in detail in this application. Code to implement the present disclosure can be stored in a non-transitory computer-readable medium such as one or more of system memory 820 or fixed disk 875. The operating system provided on controller 800 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A computer-implemented method for operating a doorbell camera, the method comprising:
capturing an image using a camera in a doorbell unit, the doorbell unit being wired to doorbell wiring, the doorbell wiring comprising a first wire and a second wire; and
sending data associated with the capturing of the image over the doorbell wiring.

2. The method of claim 1, wherein the doorbell wiring comprises at least a portion of preexisting doorbell wiring that predates an installation of the doorbell unit.

3. The method of claim 2, wherein the installation of the doorbell unit comprises replacing a preexisting doorbell unit with the doorbell unit, the preexisting doorbell unit being wired with the preexisting doorbell wiring.

4. The method of claim 1, further comprising:
continuously capturing images via the camera at a predetermined frame rate according to a setting of a user policy.

5. The method of claim 1, further comprising:
detecting motion via a sensor in the doorbell unit; and
upon detecting the motion via the sensor, capturing one or more images via the camera.

6. The method of claim 5, further comprising:
upon determining that the camera is set to record continuously, adjusting a frame rate of the camera from a first frame rate to a second frame rate upon detecting the motion via the sensor.

7. The method of claim 1, further comprising:
detecting a press of a button on the doorbell unit; and
upon detecting the press of the button, capturing one or more images via the camera.

8. The method of claim 1, further comprising:
upon determining that the camera is set to record continuously, adjusting a frame rate of the camera from a first frame rate to a second frame rate upon detecting the press of the button.

9. The method of claim 1, further comprising:
receiving, over the doorbell wiring, a request to capture one or more images using the camera; and
sending the requested one or more images to a computing device for display.

10. The method of claim 1, further comprising:
sending, over the doorbell wiring, the data from the doorbell unit to a chime unit, the doorbell unit being installed on an exterior of a dwelling and the chime unit being installed on an interior of the dwelling.

11. A computer-implemented method for operating a doorbell camera, the method comprising:
receiving, at a chime unit, data associated with capturing an image using a camera in a doorbell unit, the data being sent over doorbell wiring between the chime unit and the doorbell unit, the doorbell wiring comprising a first wire and a second wire.

12. The method of claim 11, further comprising:
sending the data received at the chime unit to a control unit over a data communication network.

13. The method of claim 11, further comprising:
receiving a request to capture one or more images using the camera in the doorbell unit; and
sending, over the doorbell wiring, the request from the chime unit to the doorbell unit.

14. The method of claim 13, further comprising:
receiving, at the chime unit, the requested one or more images over the doorbell wiring.

15. The method of claim 14, further comprising:
sending, from the chime unit, the requested one or more images to a control unit over a data communication network.

16. The method of claim 14, further comprising:
sending, from the chime unit, the requested one or more images to a computing device over a data communication network.

17. An apparatus for operating a doorbell camera, comprising:
a processor;
memory in electronic communication with the processor; and
instructions stored in the memory, the instructions being executable by the processor to:
capture an image using a camera in a doorbell unit, the doorbell unit being wired to doorbell wiring, the doorbell wiring comprising a first wire and a second wire; and
send data associated with the capturing of the image over the doorbell wiring.

18. The apparatus of claim 17, wherein the doorbell wiring comprises at least a portion of preexisting doorbell wiring that predates an installation of the doorbell unit.

19. The apparatus of claim 17, wherein the installation of the doorbell unit comprises replacing a preexisting doorbell unit with the doorbell unit, the preexisting doorbell unit being wired with the preexisting doorbell wiring.

20. The apparatus of claim 17, wherein the instructions being further executable by the processor to:
continuously capture images via the camera at a predetermined frame rate according to a setting of a user policy.
